(19) United States
(12) Patent Application Publication
(10) Pub. No.: US 2006/0231337 A1
(43) Pub. Date: Oct. 19, 2006

(54) Elevated oil reservoir collection and distribution system

(75) Inventor: Scott D. Vogeltanz, Menomonee Falls, WI (US)

Correspondence Address: QUARLES & BRADY LLP, 411 E. WISCONSIN AVENUE, SUITE 2040, MILWAUKEE, WI, 53202-4497, US

(73) Assignee: The Falk Corporation

(21) Appl. No.: 11/103,131

(22) Filed: Apr. 11, 2005

(51) Int. Cl. F16N 29/00

(52) U.S. Cl. 184/6

(57) ABSTRACT

A lubrication system comprises an elevated reservoir with a gravity-operated lubrication distribution system that achieves economy, reliability and improved thermal capacity.

### FIELD OF THE INVENTION

The invention relates to lubrication systems for mechanisms with rotating elements, and more particularly to economical lubrication systems for such mechanisms that have high efficiency and reliability.

### BACKGROUND OF THE INVENTION

A mechanism with rotating elements, such as a gear drive for industrial applications, requires a lubricant, typically oil, to lubricate revolving elements to improve efficiency and reduce wear. The same lubricant that is vital to the life of the revolving elements may be detrimental to the thermal rating of the mechanism. This detrimental effect of the lubricant is due to losses due to churning of the lubricant by the revolving elements in a sump provided for the lubricant and the resulting heat generation. The resulting heat must be removed from the mechanism without adversely affecting the distribution of lubricants to the rotating elements.

The simplest method of lubricating the revolving elements is to have a sump lubricant level such that all the revolving elements are dipping in the lubricant. This guarantees that all components have abundant lubrication at all times. The drawback to this method is that it induces high churning losses and resulting heat generation. This is because some of the revolving elements are deeply immersed in oil at all times in order that the highest elements dip into the lubricant.

An improved method of lubrication uses a plurality of lubricant collectors and troughs to reduce the lubricant level in the sump so that only the lowest rotating elements dip into the lubricant. The rotating elements that dip into lubricant disperse lubricant into the oil collectors and the troughs direct the collected lubricant to those rotating elements that do not dip into the lubricant. Unfortunately, elements that do not directly dip into lubricant are thus starved for lubricant until it reaches them by way of the lubricant collectors and troughs. Component failure results if lubricant does not reach them in an acceptable length of time.

A better method of lubrication that prevents starvation of lubricant to any of the rotating elements uses a pressure lubrication system. A pressure lubrication system comprises a lubrication supply pump that draws oil from the sump and delivers it to all of the revolving elements through a system of channels or pipes. This lubrication system permits a lower level of lubricant in the sump, resulting in less churning of lubricant and resultant heat loss. However, such a pressure lubrication system has inherently higher cost lower reliability due to failure or leakage of the pump and piping.

### SUMMARY OF THE INVENTION

The invention overcomes the performance, reliability and cost problems of prior art methods of lubrication for mechanisms with rotating elements by employing a lubrication system that comprises an elevated reservoir with a gravity-operated lubrication distribution system that achieves economy, reliability and improved thermal capacity. The initial level of lubricant in the sump is sufficient to dip all rotating elements upon start-up. The lubrication system splashes or pumps lubricant into an elevated reservoir after start-up to lower the level of lubricant in the sump so that only the lowest revolving elements dip into lubricant to reduce churning and resultant heat generation. Strategically placed orifices in the bottom of the elevated reservoir spill lubricant onto the highest revolving elements that do not dip into lubricant to prevent starvation of lubricant to these elements after start-up.

In a preferred embodiment, the invention comprises a lubrication system for a machine that has a plurality of revolving elements and a sump for collecting and retaining lubricant for the revolving elements with a first lubrication level sufficient to let all of the revolving elements dip into the lubricant upon start-up of the machine, comprising: an elevated reservoir for lubricant positioned above the revolving elements comprising a lubricant distribution system that distributes lubricant to at least some of the revolving elements by operation of gravity; and a lubricant transfer system for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

### DESCRIPTION OF THE DRAWINGS

FIG. 1 is a side view of a gear drive that has a lubrication system according to one embodiment of the invention with splash-operated lubricant transfer and gravity-operated lubricant distribution.

FIG. 2 is a side view of a gear drive that has a lubrication system according to another embodiment of the invention with pump-operated lubrication transfer and gravity-operated lubricant distribution.

FIG. 3 is a top view of the gravity-operated distribution system for the embodiments shown in FIGS. 1 and 2.

### DETAILED DESCRIPTION OF THE INVENTION

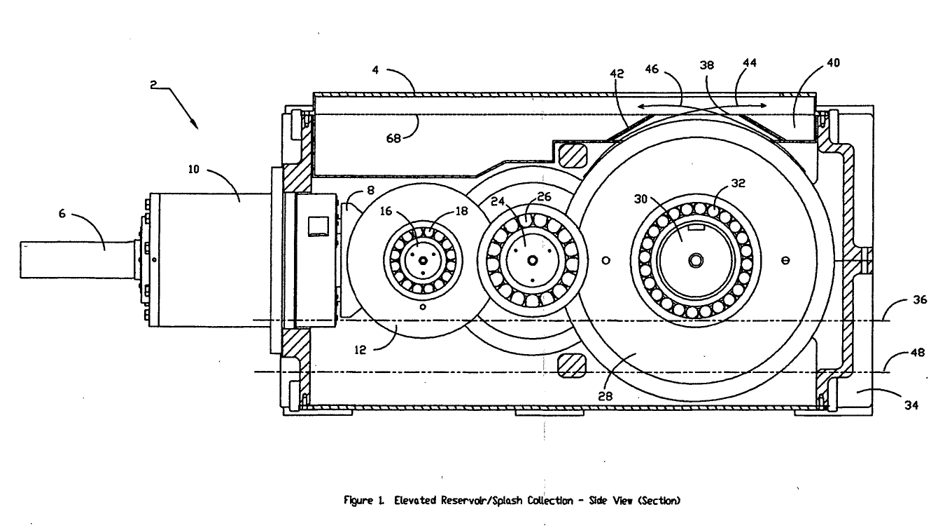

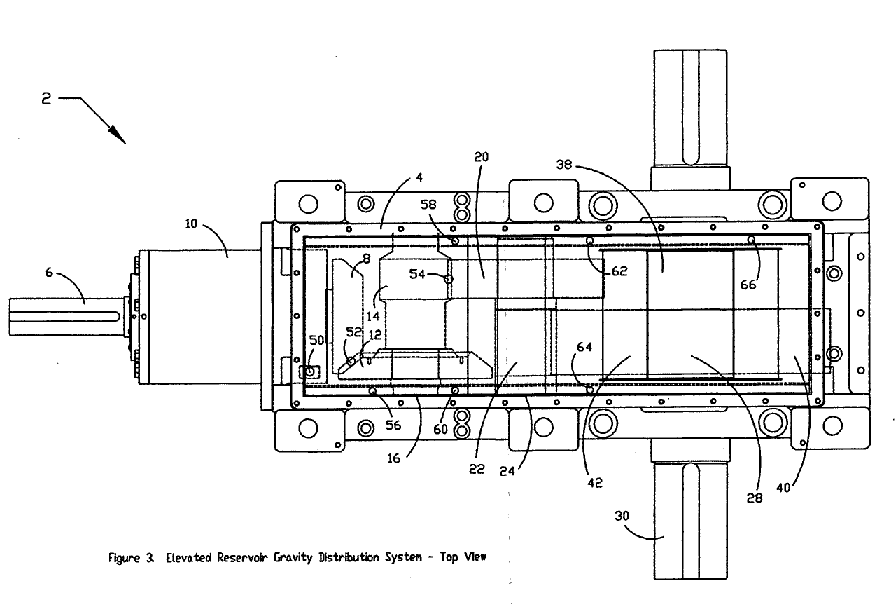

The invention is applicable to mechanisms, such as industrial gear drives, that have rotating elements. FIG. 1 is a side view of a gear drive 2 that has a lubrication system according to one embodiment of the invention with splash lubricant collection and gravity-operated distribution of lubricant. FIG. 3 is a top view of the gear drive 2. Referring to FIGS. 1 and 3 together, the gear drive 2 comprises an elevated reservoir 4 that mounts along a top surface of the gear drive 2 and conveniently acts as an upper access cover for the gear drive 2. The gear drive 2 also has a high-speed shaft 6 that couples to a high-speed right angle gear 8 supported by a right angle gear housing 10. The right angle gear 8 couples to a first intermediate gear 12 that drives a first intermediate pinion 14 by way of a first coupling shaft 16 supported by a first pair of bearings 18. The first intermediate pinion 14 couples to a second intermediate gear 20 that drives a second intermediate pinion 22 by way of a second coupling shaft 24 supported by a second pair of bearings 26. The second intermediate pinion 22 couples to a low-speed gear 28 that drives a low-speed shaft 30 supported by a pair of low-speed bearings 32.

The gear drive has a lubrication sump region 34. Lubricant fills the sump 34 to a first level before start-up such that all of the revolving elements described above dip into lubricant, as indicated by dashed line 36. The elevated reservoir 4 has a an opening 38 positioned above the largest gear, the low-speed gear 28, with a trough system 40 on the sides and output end to catch lubricant that the low-speed gear 28 splashes up upon start-up and directs it into the reservoir 4. The input end has a baffle 42 to retain the lubricant in the reservoir 4.

The elevated reservoir 4 collects lubricant for both possible rotations of the low-speed output gear 28. In one direction of rotation, lubricant splashes into the trough system 40 as shown by first arrow 44. The trough system 40 collects the lubricant and directs it into the elevated reservoir 4. In the opposite direction, lubricant splashes over the baffle 42 as shown by second arrow 46 into the elevated reservoir 4.

The low-speed gear 28, in combination with the complimentary reservoir opening 38, trough system 40 and baffle 42 in the elevated reservoir 4, acts as a lubricant transfer system that transfers lubricant from the sump 34 to the elevated reservoir 4. As the low-speed gear 28 splashes lubricant into the elevated reservoir 4 to transfer lubricant from the sump 34 to the elevated reservoir 4, the lubricant level in the sump 34 diminishes to a second level indicated by broken line 48, at which level only the low-speed gear 28 continues to dip into the lubricant that is present in the sump 34. Consequently, churning of lubricant and resulting heat generation are reduced to a minimum.

The elevated reservoir 4 also comprises a gravity-operated lubrication distribution system. This gravity-operated lubrication system comprises a series of orifices that allow lubricant to fall onto revolving elements that do not dip into the lubricant that is in the sump 34 as the lubricant level falls from the first level 36 to the second level 48. Referring to FIG. 3 in particular, these orifices comprise an orifice 50 over the right angle gear housing 10, an orifice 52 over the meshed regions of gears 8 and 12, an orifice 54 over the meshed regions of pinion 14 and orifices 56, 58, 60, 62, 64 and 66 over the bearing pairs 18, 26 and 32.

The orifices 50 through 66 are sized so that lubricant fills the elevated reservoir 4 faster than it drains from the orifices 50 through 66 in normal operation. This insures that the lubricant in the sump 34 drops from the first level 36 to the second level 48 during start-up so that churning of lubricant and resulting heat generation is kept to a minimum, thus improving the thermal rating of the gear drive 2.

Dashed line 68 represents a maximum fill level for the elevated reservoir 4. The reservoir opening 38 maintains this maximum fill level 68 by letting any overflow to spill down through it into the sump 34. This feature prevents the level of lubricant in the sump 34 from falling below the second level 48.

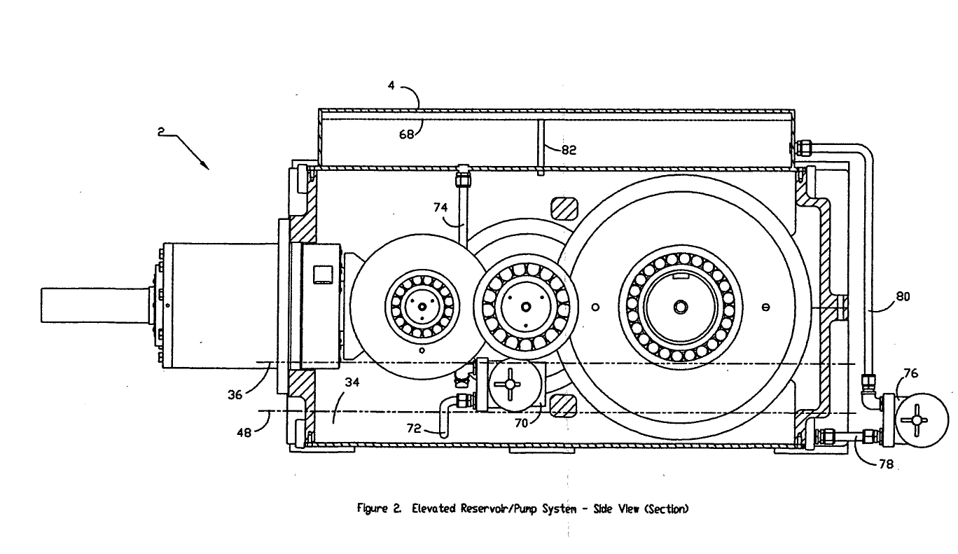

FIG. 2 is a side view of the gear drive 2 that has a lubrication system according to another embodiment of the invention with pump-operated transfer of lubricant and gravity-operated distribution of lubricant. It is much the same as the first embodiment described above in connection with FIGS. 1 and 3, except it has an internal shaft-driven pump 70 with internal inlet tubing 72 connecting its inlet to the sump 34 and internal outlet tubing 74 connecting its outlet to the elevated reservoir 4. Alternatively, or in addition, an external motor-driven pump 76 with external inlet tubing 78 and external outlet tubing 80 may be used. The elevated reservoir 4 has no reservoir opening 38, trough system 40 or baffle 42. The pump 70 or 76 draws lubricant from the sump 34, instead of relying on the splashing of lubricant from the low-speed gear 28, and transfers it to the elevated reservoir 4. Thus, this embodiment of the invention has a pump-operated lubricant transfer system that transfers lubricant from the sump 34 to the elevated reservoir 4.

Once again, the lubricant in the sump 34 has a first level 36 upon start-up that guarantees that all the revolving elements are dipping in lubricant. After start-up, the pump 70 or 76, transfers lubricant to the elevated reservoir 4 at a rate that reduces the level of the lubricant in the sump 34 to the second level 48, so that only the low-speed gear 28 dips into the lubricant, thereby keeping the churning of lubricant and resulting heat generation to a minimum.

An overflow tube 82 maintains the elevated reservoir maximum fill level 68 for this embodiment by letting any overflow to spill down through it into the sump 34. This feature both prevents the level of lubricant in the sump 34 from falling below the second level 48 and prevents the possibility pressure developing in the elevated reservoir 4 so as to cause overload of the pumps 70 or 76.

Other embodiments of the invention representing combinations of the embodiments described above shall be apparent to those skilled in the art. For instance, a gear drive 2 may employ a lubricant transfer system that transfers lubricant from the sump 34 into the elevated reservoir 4 both by splashing action of at least one of the rotating elements, as described in the first embodiment in connection with FIG. 1, and by pumping lubricant from the sump 34 into the elevated reservoir by a pump 70 or 76, as described in the second embodiment in connection with FIG. 2. This embodiment that combines lubricant transfer systems described above may be useful in cases where one lubricant transfer system alone might not be adequate to supply enough lubricant to the elevated reservoir 4.

Described above is a lubrication system that comprises an elevated reservoir with a gravity-operated lubrication distribution system that achieves economy, reliability and improved thermal capacity. It shall be apparent to those skilled in the art that although the described embodiments of lubrication system has been described as employed by a right angle gear drive, it can be similarly applied to many other machines that have rotating elements, such as double, triple and other parallel shaft gear drives. It should be understood that the described embodiments are only illustrative implementations of the invention, that the various parts and arrangement thereof may be changed or substituted, and that the invention is only limited by the scope of the attached claims.

What is claimed is:

1. A lubrication system for a machine that has a plurality of revolving elements and a sump for collecting and retaining lubricant for the revolving elements with a first lubrication level sufficient to let all of the revolving elements dip into the lubricant upon start-up of the machine, comprising:
an elevated reservoir for lubricant positioned above the revolving elements comprising a lubricant distribution system that distributes lubricant to at least some of the revolving elements by operation of gravity; and
a lubricant transfer system for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

2. The lubrication system of claim 1, wherein the lubrication transfer system comprises at least one of the revolving elements that splashes lubricant through an opening in the elevated reservoir.

3. The lubrication system of claim 2, wherein the opening in the elevated reservoir is flanked by a trough system and a baffle to collect and direct splashed lubricant into the elevated reservoir.

4. The lubrication system of claim 3, wherein the lubrication transfer system further comprises an internal pump driven by one of the rotating elements that pumps lubricant from the sump to the elevated reservoir.

5. The lubrication system of claim 3, wherein the lubrication transfer system further comprises an external motor driven pump that pumps lubricant from the sump to the elevated reservoir.

6. The lubrication system of claim 5, wherein the lubrication transfer system further comprises an internal pump driven by one of the rotating elements that pumps lubricant from the sump to the elevated reservoir.

7. The lubrication system of claim 1, wherein the lubrication transfer system comprises an internal pump driven by one of the rotating elements that pumps lubricant from the sump to the elevated reservoir.

8. The lubrication system of claim 1, wherein the lubrication transfer system comprises an external motor driven pump that pumps lubricant from the sump to the elevated reservoir.

9. The lubrication system of claim 8, wherein the lubrication transfer system further comprises an internal pump driven by one of the rotating elements that pumps lubricant from the sump to the elevated reservoir.

10. The lubrication system of claim 1, wherein the gravity-operated distribution system in the elevated reservoir comprises a plurality of orifices that drip lubricant onto the revolving elements.

11. The lubrication system of claim 1, wherein the opening in the elevated reservoir maintains a maximum lubricant fill level by letting any overflow of lubricant to spill down through it into the sump to prevent the level of lubricant in the sump from falling below the second level.

12. A lubrication system for a machine that has a plurality of revolving elements and a sump for collecting and retaining lubricant for the revolving elements with a first lubrication level sufficient to let all of the revolving elements dip into the lubricant upon start-up of the machine, comprising:
an elevated reservoir for lubricant positioned above the revolving elements comprising a lubricant distribution system that comprises a plurality of orifices that drip lubricant onto at least some of the revolving elements by operation of gravity; and
a lubricant transfer system for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

13. The lubrication system of claim 12, wherein the lubrication transfer system comprises at least one of the revolving elements that splashes lubricant through an opening in the elevated reservoir.

14. The lubrication system of claim 13, wherein the opening in the elevated reservoir is flanked by a trough system and a baffle to collect and direct splashed lubricant into the elevated reservoir.

15. The lubrication system of claim 14, wherein the opening in the elevated reservoir maintains a maximum lubricant fill level by letting any overflow of lubricant to spill down through it into the sump to prevent the level of lubricant in the sump from falling below the second level.

16. The lubrication system of claim 15, wherein the lubrication transfer system further comprises an internal pump driven by one of the rotating elements that pumps lubricant from the sump to the elevated reservoir.

17. The lubrication system of claim 15, wherein the lubrication transfer system further comprises an external motor driven pump that pumps lubricant from the sump to the elevated reservoir.

18. The lubrication system of claim 17, wherein the lubrication transfer system further comprises an internal pump driven by one of the rotating elements that pumps lubricant from the sump to the elevated reservoir.

19. The lubrication system of claim 12, wherein the lubrication transfer system comprises an internal pump driven by one of the rotating elements that pumps lubricant from the sump to the elevated reservoir.

20. The lubrication system of claim 19, further comprising an overflow tube in the elevated reservoir to maintain a maximum lubricant fill level by letting any overflow of lubricant to spill down through it into the sump to prevent the level of lubricant in the sump from falling below the second level and to prevent the possibility of pressure developing in the elevated reservoir so as to cause pump overload.

21. The lubrication system of claim 12, wherein the lubrication transfer system comprises an external motor driven pump that pumps lubricant from the sump to the elevated reservoir.

22. The lubrication system of claim 21, further comprising an overflow tube in the elevated reservoir to maintain a maximum lubricant fill level by letting any overflow of lubricant to spill down through it into the sump to prevent the level of lubricant in the sump from falling below the second level and to prevent the possibility of pressure developing in the elevated reservoir so as to cause pump overload.

23. The lubrication system of claim 22, wherein the lubrication transfer system further comprises an internal pump driven by one of the rotating elements that pumps lubricant from the sump to the elevated reservoir.

24. A lubrication system for a machine that has a plurality of revolving elements and a sump for collecting and retaining lubricant for the revolving elements with a first lubrication level sufficient to let all of the revolving elements dip into the lubricant upon start-up of the machine, comprising:
an elevated reservoir for lubricant positioned above the revolving elements comprising a lubricant distribution system that comprises a plurality of orifices that drip lubricant onto at least some of the revolving elements by operation of gravity; and
a lubricant transfer system that comprises at least one of the revolving elements that splashes lubricant through an opening in the elevated reservoir for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

25. The lubrication system of claim 24, wherein the opening in the elevated reservoir is flanked by a trough system and a baffle to collect and direct splashed lubricant into the elevated reservoir.

26. The lubrication system of claim 25, wherein the opening in the elevated reservoir maintains a maximum lubricant fill level by letting any overflow of lubricant to spill down through it into the sump to prevent the level of lubricant in the sump from falling below the second level.

27. The lubrication system of claim 26, wherein the lubrication transfer system further comprises an internal pump driven by one of the rotating elements that pumps lubricant from the sump to the elevated reservoir.

28. The lubrication system of claim 26, wherein the lubrication transfer system further comprises an external motor driven pump that pumps lubricant from the sump to the elevated reservoir.

29. The lubrication system of claim 28, wherein the lubrication transfer system further comprises an internal pump driven by one of the rotating elements that pumps lubricant from the sump to the elevated reservoir.

30. A lubrication system for a machine that has a plurality of revolving elements and a sump for collecting and retaining lubricant for the revolving elements with a first lubrication level sufficient to let all of the revolving elements dip into the lubricant upon start-up of the machine, comprising:
an elevated reservoir for lubricant positioned above the revolving elements comprising a lubricant distribution system that comprises a plurality of orifices that drip lubricant onto at least some of the revolving elements by operation of gravity; and
a lubricant transfer system that comprises an internal pump driven by one of the rotating elements that pumps lubricant from the sump to the elevated reservoir for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

31. The lubrication system of claim 30, further comprising an overflow tube in the elevated reservoir to maintain a maximum lubricant fill level by letting any overflow of lubricant to spill down through it into the sump to prevent the level of lubricant in the sump from falling below the second level and to prevent the possibility of pressure developing in the elevated reservoir so as to cause pump overload.

32. The lubrication system of claim 31, wherein the lubrication transfer system further comprises an external motor driven pump that pumps lubricant from the sump to the elevated reservoir.

33. A lubrication system for a machine that has a plurality of revolving elements and a sump for collecting and retaining lubricant for the revolving elements with a first lubrication level sufficient to let all of the revolving elements dip into the lubricant upon start-up of the machine, comprising:
an elevated reservoir for lubricant positioned above the revolving elements comprising a lubricant distribution system that comprises a plurality of orifices that drip lubricant onto at least some of the revolving elements by operation of gravity; and
a lubricant transfer system that comprises an external motor driven pump that pumps lubricant from the sump to the elevated reservoir for transferring lubricant from the sump to the elevated reservoir after start-up of the machine to reduce the lubricant in the sump to a second level lower than the first level such that no more than one revolving element dips into the lubricant retained in the sump, thereby reducing churning of lubricant by the revolving elements and reducing heat generation.

34. The lubrication system of claim 33, further comprising an overflow tube in the elevated reservoir to maintain a maximum lubricant fill level by letting any overflow of lubricant to spill down through it into the sump to prevent the level of lubricant in the sump from falling below the second level and to prevent the possibility of pressure developing in the elevated reservoir so as to cause pump overload.
